(19) United States
(12) Patent Application Publication
(10) Pub. No.: US 2015/0259944 A1
(43) Pub. Date: Sep. 17, 2015

(54) Headstone Halo

(71) Applicant: James McPeak, Culpeper, VA (US)

(72) Inventor: James McPeak, Culpeper, VA (US)

(21) Appl. No.: 14/208,497

(22) Filed: Mar. 13, 2014

(51) Int. Cl. E04H 13/00; A61G 99/00; F21V 33/00; F21S 9/03; F21S 8/08

(52) U.S. Cl. CPC E04H 13/001; F21S 9/035; F21S 8/08; F21V 33/0004; A61G 99/00; E04H 13/003; F21Y 2111/00

(57) ABSTRACT

A memorial light assembly for mounting on a headstone at a gravesite. The light assembly comprises a light source capable of displaying continuous light at a gravesite. The light source is suspended above the gravesite by means of a base adapted for mounting on a headstone. The base houses a solar powered energy means to power the light source. The light assembly continuously emits a halo and is positioned at a gravesite where it displays the halo to a mourner and thereby causes the mourner to experience an uplifting emotion when visiting the gravesite.

### REFERENCE TO RELATED APPLICATION

This patent application claims the benefit of U.S. Provisional Application No. 61/851,745 filed on Mar. 13, 2013, the disclosure of which is incorporated herein by reference in its entirety.

### BACKGROUND OF THE INVENTION

1. Field of the Invention

This invention functions as a memorial to a deceased loved one, specifically it is a light assembly for attachment to a headstone at a gravesite. The light assembly comprises a solar powered illumination device configured to project continuously a selected light pattern at the website. Preferably the illumination device comprises a circular light bulb with an outer circular configuration designed to simulate a halo.

2. Description of Related Art

Memorializing a gravesite by means of illuminating devices attached to a headstone are known in the prior art. More specifically, by way of example, U.S. Pat. No. 6,761,465 to Little discloses an illuminated headstone mounting assembly.

U.S. Pat. No. 6,951,408 to Stewart discloses a monument illuminator wherein a lamp is directed to the monument is a solar powered solar panel attached to the monument.

U.S. Pat. No. 6,132,054 to Rogers discloses a pair of light sources configured to resemble a pair of candles for mounting to the top of a headstone.

U.S. Pat. No. 6,637,911 to Sittner discloses a solar powered light attached to front and back of a gravestone.

U.S. Pat. No. 8,585,231 to May discloses a grave marker assembly related to grave and burial site assemblies which facilitate displays of U.S. flags during nighttime.

This prior art discloses illuminating devices that serve as grave markers or as embellishment of headstones, but they are not designed to interact with a viewing mourner by attracting the attention of a mourner in a way that elevates the mood of the viewer.

For many people the mourning process is assisted by virtual visual displays that serve more than as grave markers or embellishment of headstones.

It is an object of this invention to provide a light assembly for attachment to a headstone at a gravesite whereby light is chosen to be of a significant pattern is displayed at the gravesite.

It is an object of this invention to provide a light assembly that projects a meaningful symbol to a gravesite where it can be viewed by a mourner and thus raise the mood of the mourner.

It is a further object of this invention to provide an illumination device that projects a light symbol continuously to remind a mourner of the constant presence of light at the gravesite.

It is a further object of this invention to provide an illumination device comprising a circular light bulb adapted to display a halo at the gravesite.

It is a further object of this invention to provide an illumination device that is capable of surviving severe seasonal weather conditions for an extended period of time.

### SUMMARY OF THE INVENTION

In an exemplary embodiment of the present invention, there is disclosed a light assembly for continuously displaying a halo at a gravesite where it can be viewed by a mourner.

The light assembly comprises:

A solar powered light source whereby light of a determined pattern is continuously displayed at the gravesite. Preferably the pattern displayed by the light source is a halo and the light source comprises a circular light bulb supported by an opaque ring mounted above and below the plane defined by the ring whereby the perimeter of the bulb emits a circular glow resembling a halo.

A base for mounting the light source on a headstone. The base houses a solar powered energy means whereby the light source is powered. Solar powered energy means is preferably solar powered rechargeable batteries or a photovoltaic solar module. In preferred embodiments, the base is configured to be removeably attached or reversibly mounted on the headstone.

A rigid shaft connected to said base and said light source, whereby the light source is supported at a position to cause light to be displayed at the gravesite at a location visible to a viewer. The shaft houses means for electronic communication of the solar powered energy means with the light source.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

The disclosed application will be described with reference to the accompanying drawings, which show important sample embodiments of the invention and which are incorporated in the specification hereof by reference, wherein:

FIG. 1 is an elevated view of the light assembly of the present invention illustrating a base attached to a headstone at a gravesite, a circular light source enclosed by an opaque ring and shaft positioning the light source at a gravesite and housing means for electronic communication of solar powered energy means and the circular light.

FIG. 2 illustrates the base of the light assembly of the present invention with a chamber for housing a solar powered energy means and with means for reversibly attaching the base to a headstone.

FIG. 3 illustrates the light source of the light assembly of the present invention modified to display light resembling a halo comprising a circular light bulb enclosed and supported by an opaque ring connected by a rigid shaft to the base.

FIG. 4 illustrates a varying embodiment of the present invention modified to show a larger box for a battery source.

FIG. 5. illustrates a varying embodiment of the present invention modified to show a varying clamping device of the halo to the support stem attached to the base.

FIG. 6 illustrates the device standing alone without being attached to a gravestone.

FIG. 7 illustrates how the halo projects illumination from the center ring itself.

### DESCRIPTION OF THE PREFERRED EMBODIMENT

In an exemplary embodiment of the present invention, there is disclosed a light assembly for continuously displaying a halo at a gravesite.

The halo is an ancient symbol of light often used in religious paintings and other iconography to represent higher spiritual meaning. Thus Byzantine portraits often represent the saints with halos and Jesus himself is often rendered with a halo. Homer describes a more-than-natural light around the heads of heroes in battle Iliad v.4ff, xviii.203ff. To some, the halo means the spiritual energy emanating from a person, a universal aura of high spiritual attainment.

The preferred embodiment of the present invention provides a light assembly for displaying a halo at a gravesite as a memorial to the deceased person and an inspiration to a viewing mourner.

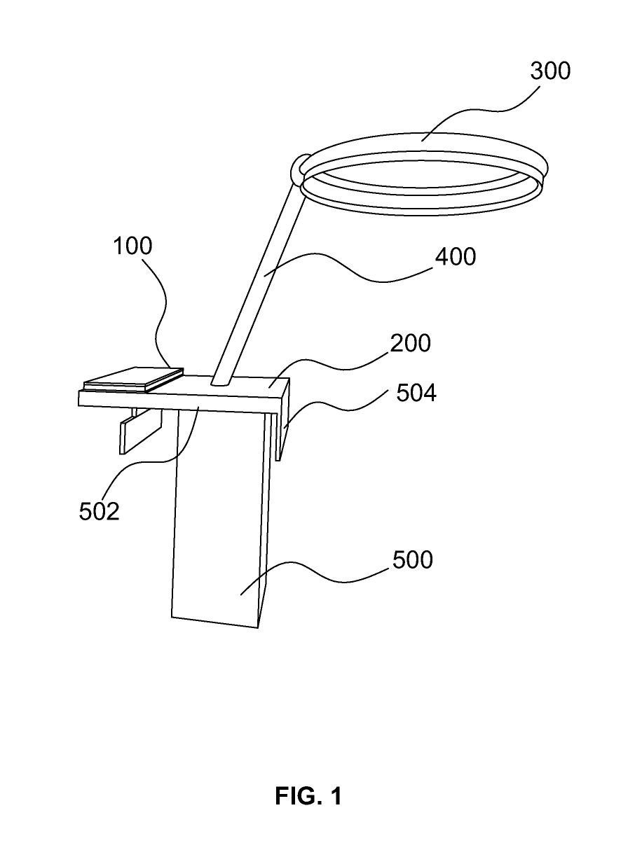

As illustrated in FIG. 1, light assembly (100) comprises base (200) adapted to be secured to a headstone at a gravesite, circular light source (300) and rigid shaft (400) connected to the base and light source. Headstones (500) are sculpted from granite or other stone into rectangular slabs that are situated vertically at the head of a gravesite. Headstones usually comprise a horizontal surface (502) at or near the top of the slab and have a vertical and one or more slightly sloping sides (504).

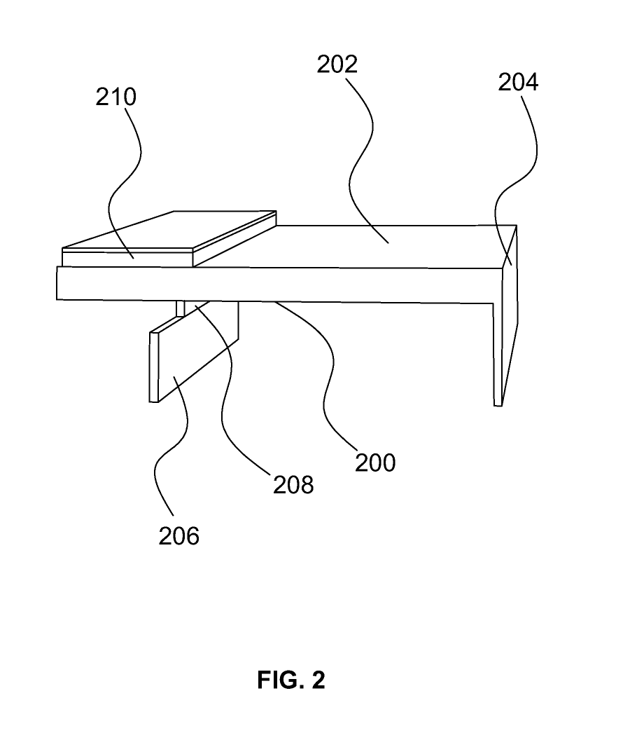

As illustrated in FIG. 2, base (200) comprises a flat surface (202) with dimensions similar to the horizontal surface (502) of a headstone. Attached to flat surface (202) is means (204, 206) for securing the base to the flat surface of the headstone. Securing means (204, 206) comprise rigid panels fixed perpendicularly to flat surface (202) to form two arms (204, 206) adapted to clamp the sides of the headstone and thereby secure flat surface (202) to the headstone. To accommodate headstones of different dimensions, width between arms (204, 206) is adjustable. Preferred embodiments comprise one stationary arm (204) and another moveable arm (206) that may be slid or otherwise moved along flat surface (202) to position arm (206) at a location that determines a desired width between arms. Width between arms (204, 206) is chosen to cause sufficient pressure on the headstone to secure flat surface (202) securely on the headstone without causing abrasion or permanent disfiguration. A determined width between arms (204, 206) is maintained by means of screws (208) or other securing means to assure that arms (204, 206) continue to exert sufficient pressure on the headstone to keep base (200) firmly attached over time.

Referring to FIG. 2, in preferred embodiments of the invention, the base is configured to be removeably attached to the headstone. In certain instances, securing means (208) may be manipulated to cause arms (204,206) to move apart to reduce their pressure on the gravestone and thereby allow base (200) to be removed from the headstone when desired. In other instances, arms (204,206) are deformable and slightly curved to form a claw-like structure that grasps the headstone. In these instances, the claw is capable of maintaining the base securely fixed to the headstone but may be easily pulled from it with simple manual force or simple tools. In yet other instances, base (200) or components of base (200) may be attached to the headstone by magnetic means

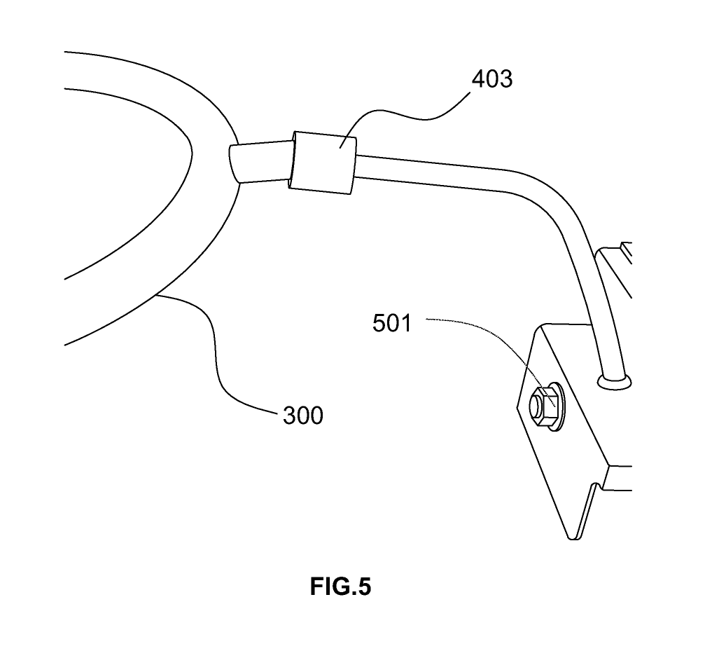

In other preferred embodiments, when disfiguration of the headstone is not a concern, as when thievery is a problem, the base may be permanently attached to a headstone by screws and bolts 501 and the like. See FIG. 5.

In the present invention, the word “headstone” is intended to mean a conventional memorial placed at a gravesite, usually a stone slab placed vertically at the head of the gravesite. “Headstone” also is meant to mean any other structure that may be placed at a gravesite or at any place to be memorialized. Base (200) may attached to other supports including a pole such as a flag pole or other structure having a surface suitable for supporting base (200). To accommodate supports having curved or irregular surfaces, base (200) may be adapted by modifying flat surface (202) to a more curved surface.

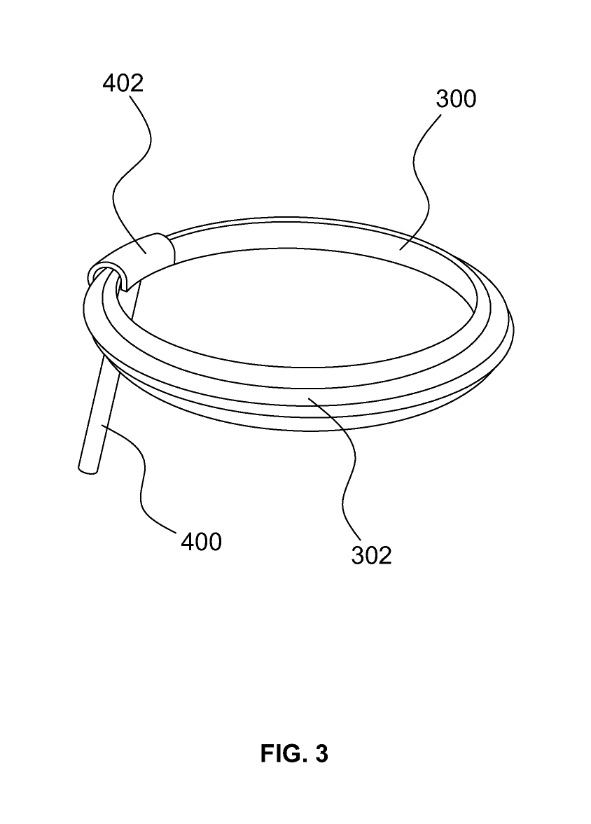

As illustrated in FIG. 3 light source (300) of the present invention is adapted to display circular light that resembles a halo. The light source is preferably a circular incandescent bulb or a liquid crystal (LED) device. Other sources of light known to the art including but not limited to, circular neon lamps, fluorescent means or glow-rings may also be light sources of the present invention.

Most light sources are point sources that emit a cone shape and radiate a diffused glow in all directions as a globe. A circular bulb emits light from its perimeter and illuminates the space above and below the plane defined by the perimeter. In the present invention, light source (300) is a circular bulb (302) encircled by and supported by opaque rings mounted at each side of the circle. The opaque rings block light radiating above and below the plane of the circular bulb and thus emit light resembling a halo.

Two opaque rings can surround and support the bulb (302) as a varying embodiment. The radius of the rings is sufficient to accommodate the circular bulb. The total width of the two rings is less than the width of the perimeter of the bulb to leave an area between the rings whereby light radiates from the perimeter of the bulb only. In this configuration light is blocked above and below the plane of the circular bulb (302) resulting in a display of light resembling a halo. Supporting rings may be comprised of any opaque, rigid material capable of securing bulb (302) in the present light assembly.

As it is expected that the present light assembly will remain unattended for long periods of time under severe weather conditions, most preferably light source (300) comprises suitable sealants and other means to ensure weatherproofing and long lasting bonding between support rings and bulb. In certain instances, circular bulb (302) may be enclosed with a transparent cover, preferably transparent plastic. In these instances the cover is securely affixed to the bulb by means that protect the light bulb from damage by weather or other forces. In these instances the cover is adapted to be easily removed from the bulb for bulb replacement.

As illustrated in FIG. 3, light source (300) is supported by rigid, hollow shaft (400) connected to base (200). The rigid shaft positions base and light source at an angle that causes light source (300) to be suspended near a gravesite where the halo may be displayed at a position easily viewed by a visiting mourner. Shaft (400) is attached to light source (300), most preferably to one or more opaque supporting rings (304) and to flat surface (202) near chamber (210). The shaft comprises a clamping means, preferably semi-circular, end (402) for supporting rings (304) and circular bulb (302) enclosed therein. Preferably the clamp comprises adjustable means to allow circular bulb (302) to be swiveled inside the clamp at different angles relative to the base and thereby to provide optimal display of the halo.

Shaft (400) is adapted to house electronic control circuitry connecting solar powered means (212) and light source (300) thereby providing means for continuous illumination of light source (300).

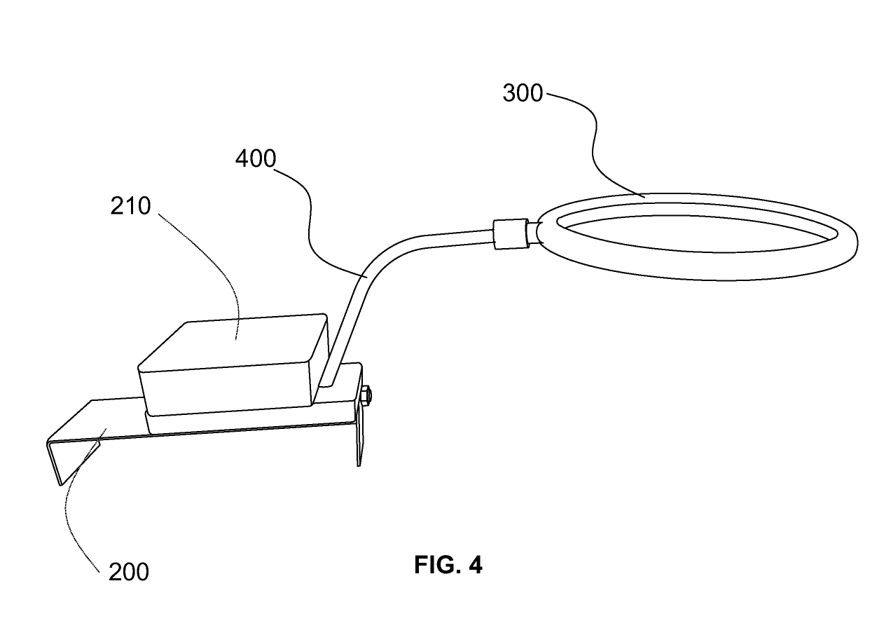

Referring to FIG. 4 the invention is shown with another embodiment. Here the power source is more centered on the base of the device and the light source 300 is one solid ring.

FIG. 5 shows another embodiment of the present invention. Here there is presented a varying shaft 403 for connection to light source. Here a circular clamping device 403 is used to hold the light source to the shaft 400 instead of a semi circular clamp that is depicted in FIG. 1. This allows for the light source to be bent to varying directions to help direct the way the light will be emitted.

Referring to FIG. 5, base (200) comprises chamber (210) for housing solar powered means (212) for generating energy to power light source (300). In preferred embodiments, the generating means is one or more batteries rechargeable by light. In these embodiments chamber (210) is configured to accommodate a battery pack having a number of batteries sufficient to continuously power light source (300). Battery packs of Ni/Cd batteries are commercially available to provide convenient and inexpensive energy. Ni/Cd batteries are charged during the day with sun or a photovoltaic device and permit light to be displayed at dusk to dawn. The extended lifetime of solar powered batteries makes them especially suitable for use in the present invention where continuous light requires a long-acting power source.

Solar powered means (212) may be any photo-voltaic source or solar module known to the art. In these embodiments, chamber (210) may be adapted to accommodate said modular solar powered panels. In other embodiments solar powered means may be directly attached to light source (300) by other means. In certain instances, the photovoltaic cell is electrically connected to batteries to store energy for later use to power the light assembly.

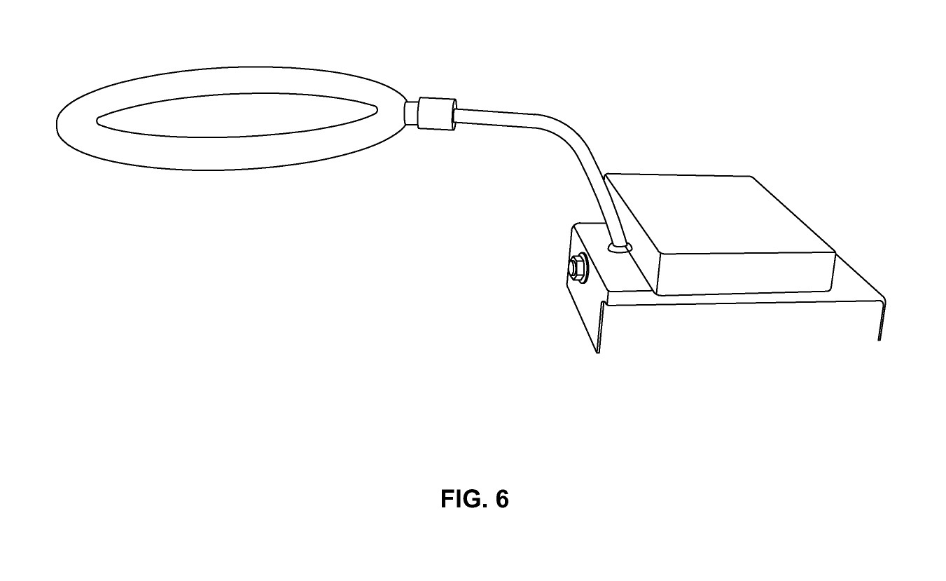

FIG. 6 shows the complete device using the embodiment of the shaft described in FIG. 5.

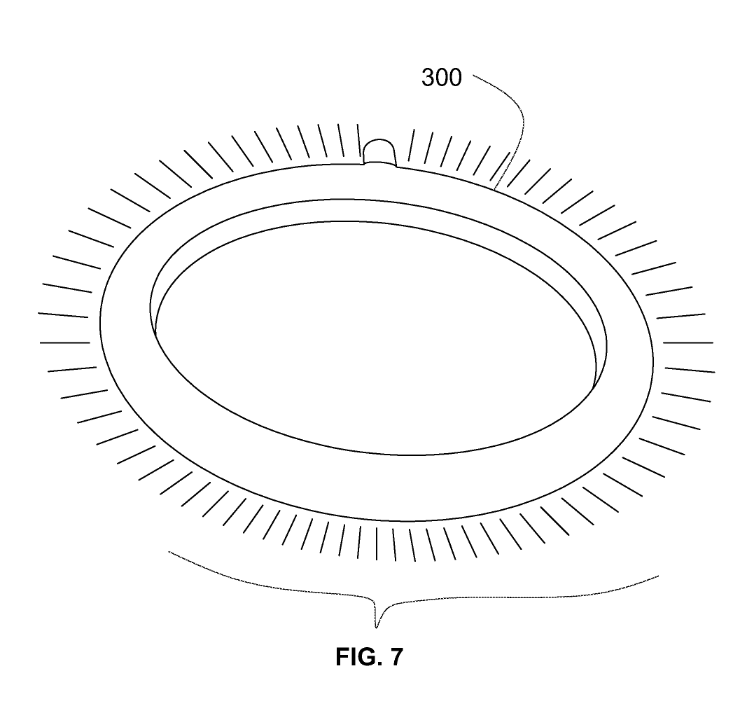

FIG. 7 shows how the light source is emitted from the circular ring itself. Referring to FIG. 7, light source (300) may be adapted to achieve a particular lighting effect. Incandescent bulbs may be coated with phosphorescent materials or treated to achieve iridescence. The materials used for LED have a direct band gap with energies corresponding to near-infrared, visible, or near-ultraviolet light to provide light of different colors. If desired, the circular bulb may be colored, textured, printed or embossed with a graphic design or otherwise treated.

The light assembly comprising base, light source and shaft preferably comprises any material that provides strength and flexibility to the device over an extended length of time. To satisfy an important object of the invention, the present light assembly is intended to be manufactures by low cost methods and materials. To this end, fabrication of the assembly is to be achieved by commonly accepted means and components including light bulb and solar powered energy devices. In addition, the assembly must be weatherproofed to survive extended exposure to seasonal weather variations. The base and shaft may be fabricated or molded from material such as plastic, preferably a thermoplastic or plastic polymer, metal or a wood engineered product by any known method. Preferably the light assembly/base is manufactured by injection molding from thermoplastic or thermosetting polymers. The scope of the present invention is intended to include the moulds designed in the manufacture of the auxiliary handle by injection molding.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

1. A light assembly comprising a solar powered light source and means for mounting the light source on a headstone at a gravesite whereby light of a determined pattern is continuously displayed at the gravesite.

2. The light assembly of claim 1 wherein the determined pattern displayed by the light source is a halo.

3. The light assembly of claim 2 wherein the light source comprises a circular light bulb supported by an opaque ring mounted above and below the plane defined by the ring whereby the perimeter of the bulb emits a circular glow resembling a halo.

4. The light assembly of claim 1 comprising a base for mounting the light source on a headstone.

5. The base of claim 4 housing a solar powered energy means whereby the light source is powered.

6. The light assembly of claim 4 wherein the base is configured to be reversibly mounted on the headstone.

7. The base of claim 5 wherein the solar powered energy means comprises solar powered rechargeable batteries or a photovoltaic solar module.

8. The light assembly of claim 1 comprising a rigid shaft connected to said base and said light source whereby the light source is supported at a position whereby light is be displayed at the gravesite at a location visible to a viewer.

9. The shaft of claim 8 housing means for electronic communication of the solar powered energy means with the light source.

10. The light assembly of claim 1 comprising:
a. Light source for continuously displaying light resembling a halo at the gravesite;
b. Base for mounting the light source on a gravestone at the gravesite, the base housing a solar powered energy means; and
c. Shaft connecting the light source to said base, the shaft housing means for electronic communication of the solar powered energy means and the light source and rigidly supporting the light source at a location whereby light is displayed at the gravesite where it is visible to a viewer.
